(19) United States
(12) Patent Application Publication
(10) Pub. No.: US 2009/0040925 A1
(43) Pub. Date: Feb. 12, 2009

(54) DEVICE HAVING QUALITY OF SERVICE (QoS) CONFIRMATION AND METHOD FOR CONFIGURING QoS

(76) Inventors: Jarl Tomas Holmstrom, Dalby (SE); Olle Franceschi, Landskrona (SE); Svante Alnas, Lund (SE)

Correspondence Address: ERICSSON INC., 6300 LEGACY DRIVE, M/S EVR 1-C-11, PLANO, TX, 75024, US

(21) Appl. No.: 12/249,160

(22) Filed: Oct. 10, 2008

Related U.S. Application Data
(63) Continuation-in-part of application No. 11/276,838, filed on Mar. 16, 2006.
(60) Provisional application No. 60/979,430, filed on Oct. 12, 2007.
(60) Provisional application No. 60/663,901, filed on Mar. 21, 2005.

(51) Int. Cl. H04L 12/26

(52) U.S. Cl. 370/230

(57) ABSTRACT

A UE is described herein that has a defined QoS database which is used to organize and store various QoS parameter sets which are used to help establish media flows. In one embodiment, the QoS database includes a plurality of tables, where each table is associated with a particular application, and where each table has a plurality of rows, and where each row includes a media type, a requested QoS parameter set, and an optional minimum QoS parameter set. An operator can use a communication network to populate/provision the QoS database. An operator can also use the communication network to fine-tune (update) the QoS database which enables them to enhance the bearer QoS for existing applications and to enable the appropriate bearer QoS for future applications.

### CROSS-REFERENCE TO RELATED APPLICATIONS

This application claims the benefit of U.S. Provisional Application No. 60/979,430, filed Oct. 12, 2007, the disclosure of which is incorporated herein by reference. This application is also continuation-in-part of U.S. application Ser. No. 11/276,838, filed Mar. 16, 2006, which claims the benefit of U.S. Provisional Application No. 60/663,901, filed Mar. 21, 2005, the disclosure of which is incorporated herein by reference.

### FIELD OF THE INVENTION

The present invention relates to a device (e.g., user equipment (UE)) which has a quality of service (QoS) database that is remotely provisioned and/or fine-tuned over the air by an operator of a communication network.

### BACKGROUND OF THE INVENTION

Referring to FIG. 1, there is shown a block diagram which is used to help explain how an application's media flow(s) 101 (e.g., a push-to-talk over cellular (PoC) application, a voice over Internet Protocol (VoIP) application, a video application, a file transfer application) is currently established between a device or User Equipment (referred to collectively as a UE) 100 and a communication network 102. Initially, the UE 100 (in particular an application 112) and the communication network 102 (which in this example has an IP Multimedia Subsystem (IMS) architecture) utilize Session Description Protocol (SDP) signaling to negotiate on an application level what type of media flow(s) 101 they want to establish (see step 1). Then, the UE 100 (in particular a session manager 124) and the communication network 102 (in particular a session manager 108) attempt to activate the bearer(s) (Packet Data Protocol (PDP) context(s)) which are needed to establish the media flow(s) 101 (see steps 2a-2c). For example, if a video application 401 was desired then there would be a voice bearer and a video bearer which would need to be activated. And, if a voice application 401 was desired then just a voice bearer would need to be activated. How these bearer(s) are activated is discussed next.

First, the UE 100 needs to generate a requested QoS parameter set 104 for each of the media flow bearer(s) which it then forwards to a Serving General Packet Radio Service (GPRS) Support Node 106 (SGSN 106) (in particular the session manager 108) within the communication network 102 (see step 2a). Secondly, the session manager 108 generates and forwards a negotiated QoS parameter set 110 for each of the bearer(s) to the UE 100 (see step 2b). Thirdly, the UE 100 (in particular the session manager 124) determines whether or not to accept the negotiated QoS parameter set(s) 110 which would be used to set-up the respective bearer(s)(see step 2c). If the UE 100 accepts the negotiated QoS parameter set(s) 110, then the media flow(s) 101 is/are established with the communication network 102 (see step 3). If the UE 100 does not accept any of the negotiated QoS parameter set(s) 110, then the corresponding bearer is deactivated and the corresponding media flow 101 is not established with the communication network 102. The step where the UE 100 generates the requested QoS parameter set(s) 104 which is sent to the communication network 102 is of particular interest. How the traditional UE 100 functions to generate the requested QoS parameter set(s) 104 is discussed next.

The traditional UE 100 can generate the requested QoS parameter set(s) 104 by using the following components: an application 112; a SDP handler 114 (optional); an Internet Protocol (IP) Bearer Service (BS) manager 116 (optional); a translation/mapping function 118; a Universal Mobile Telephone Service (UMTS) BS manager 120; a UMTS QoS Parameter Per Application Type database 122; and a session manager 124. These components 112, 114, 116, 118, 120, 122 and 124 generate the requested QoS parameter set(s) 104 as follows:

A. The application 112 provides the UMTS BS Manager 120, possibly via the IP BS Manager 116 and the Translation/Mapping function 118, the relevant information needed to perform step B or step D.

B. If needed, the UMTS BS Manager 120 uses information from step A to access a proper set of QoS Parameters from the UMTS QoS Parameter Per Application Type database 122. In this discussion, it is assumed that this step is performed.

C. If the SDP handler 114 is available, then the SDP Parameters therefrom could provide guidance for the UMTS BS Manager 120 (possibly via the IP BS manager 116 and the translation/mapping function 118) to set a maximum bitrate uplink/downlink (UL/DL) and a guaranteed bitrate UL/DL.

D. A set of QoS Parameters values from step B (or directly from step A) is possibly merged at the session manager 124 together with the maximum bitrate UL/DL and the guaranteed bitrate UL/DL from step C. The result is the requested QoS parameter set(s) 104.

For a more detailed discussion about this UE 100 and this process, reference is made to section 7.2 of 3GPP TS 29.208 v6.5.0 entitled “3rd Generation Partnership Project; Technical Specification Group Core Network and Terminals; End-to-end Quality of Service (QoS) Signalling Flows (Release 6)” September 2005. This document describes end-to-end application level negotiation signaling, such as SIP/SDP negotiation, which may take place prior to the set up of bearers for the different application flows. In e.g. IMS, SIP/SDP negotiation results in input to the ‘codec and bit rate combination’ selection needed for different media types, such as video, speech, etc.

This scheme has several disadvantages. First, the UE 100 does not have a defined UMTS QoS Parameter Per Application Type database 122 in which QoS values can be organized and stored. Secondly, an operator can not populate/provision the UMTS QoS Parameter Per Application Type database 122. Thirdly, the operator can not fine-tune (update) the QoS values stored within the UMTS QoS Parameter Per Application Type database 122.

### BRIEF DESCRIPTION OF THE INVENTION

The present invention overcomes the problems identified in the above reference, that being the manufacturer of the UE 100 often utilizes their own proprietary process to add QoS values into the UMTS QoS Parameter Per Application Type database 122. For the case of end-to-end application level negotiation signalling, such as SIP/SDP negotiation, it would be advantageous for an operator to be able to dynamically limit the set of codec and bit rate combinations, candidates for selection for the different media types, to ensure that only combinations that are in line with the current operator policies (e.g. supported bit rates) are selected. Failure to do so might result in that the application level negotiation results in that codecs and/or bit rates, that are supported in the UE but cannot be supported in the network (due to e.g. bandwidth limitations or operator policies), are selected for one or more media types. There is currently no specified method that solves the identified problem. The present invention provides such a solution.

A UE of the present invention has a defined QoS database which is used to organize and store various QoS parameter sets which are used to help establish media flows. In one embodiment, the QoS database includes a plurality of tables, where each table is associated with a particular application, and where each table has a plurality of rows, and where each row includes a media type, a requested QoS parameter set, and an optional minimum QoS parameter set. An operator can use a communication network to populate/provision the QoS database. An operator can also use the communication network to fine-tune (update) the QoS database which enables them to enhance the bearer QoS for existing applications and to enable the appropriate bearer QoS for future applications. Preferred codecs and bit rate combinations per media type may also be provisioned to the UE by the communication network, or the codec configuration and QoS values may be solely based on a request from the UE.

### BRIEF DESCRIPTION OF THE DRAWINGS

A more complete understanding of the present invention may be had by reference to the following detailed description when taken in conjunction with the accompanying drawings wherein:

FIG. 1 is a block diagram of a conventional UE and a communication network;

FIG. 2A is a block diagram of a UE which has a QoS database (e.g., enhanced UMTS QoS Parameter Per Application Type database) where QoS values can be organized and stored in accordance with the present invention;

FIG. 2B is a block diagram that illustrates in greater detail an embodiment of the format of the QoS database (e.g., enhanced UMTS QoS Parameter Per Application Type database) shown in FIG. 2A in accordance with the present invention;

FIG. 2C is a block diagram illustrating in greater detail another embodiment of the format of the QoS database (e.g., enhanced UMTS QoS Parameter Per Application Type database) shown in FIG. 2A in accordance with the present invention;

FIG. 3 is a block diagram which is used to help explain how an operator can use a communication network to populate/provision the UE's QoS database shown in FIG. 2B in accordance with the present invention; and

FIG. 4 is a block diagram which is used to help explain how the UE shown in FIG. 2A can utilize the populated QoS database therein to establish an application's media flow(s) with a communication network in accordance with the present invention.

### DETAILED DESCRIPTION OF THE DRAWINGS

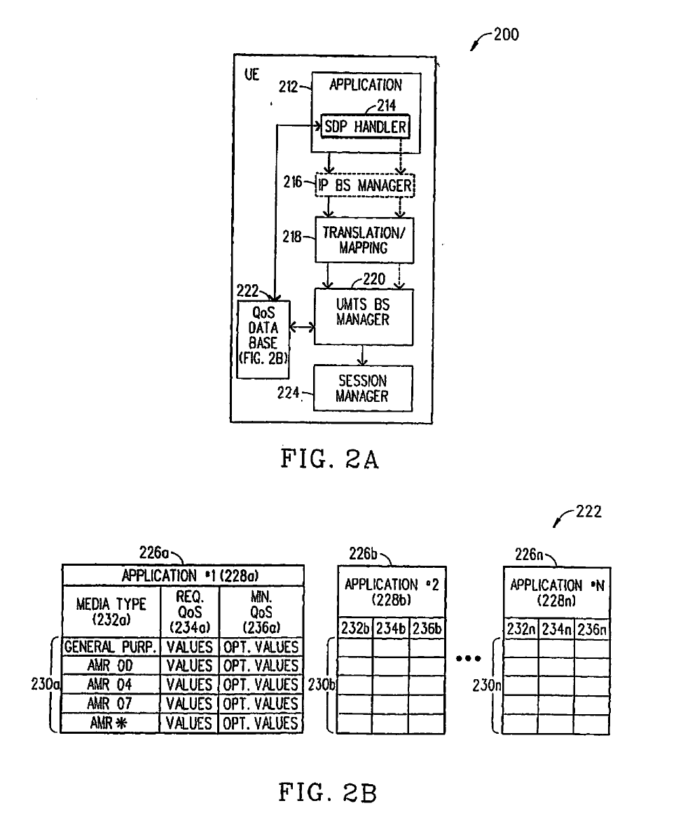

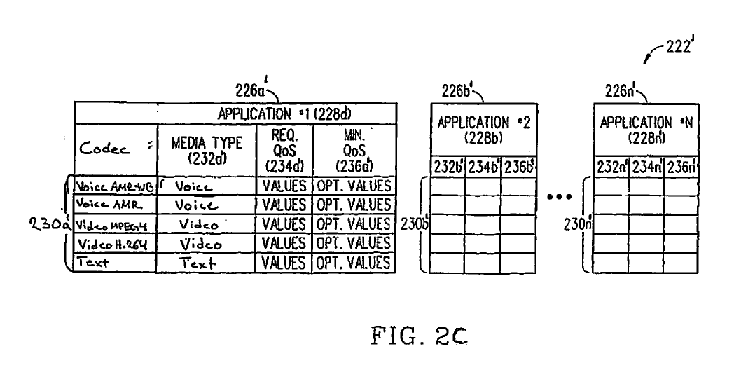

Referring to FIG. 2A, there is shown a block diagram of a UE 200 which has a QoS database 222 (e.g., enhanced UMTS QoS Parameter Per Application Type database 222) with a defined format in which QoS values are organized and stored in accordance with the present invention. The exemplary UE 200 shown has the following components (which are relevant to this discussion): an application 212; an SDP handler 214; an IP BS manager 216 (optional); a translation/mapping function 218; an UMTS BS manager 220; the QoS database 222 (e.g., an enhanced UMTS QoS Parameter Per Application Type database 224); and a session manager 226. The components 212, 214, 216, 218, 220 and 224 happen to be well known to those skilled in the art. However, the enhanced QoS database 222 is new, especially in the way it is arranged to operate, and happens to be a marked-improvement over the prior art as also will be further discussed with respect to FIGS. 2B and 2C.

The SDP handler 214 is arranged to access the QoS database 222. Besides providing the UMTS BS manager 220 with appropriate information for requesting proper bearers, the QoS database 222 provides appropriate information to the SDP handler for SIP/SDP negotiation. This enables improved efficiency in application level negotiation. The operator is enabled to control any application level negotiation to e.g., only include codec and bit rate combinations for which the required level of bearer QoS can be fulfilled by the network. This increases the probability of a successful activation of the application. This applies to use cases both with UE and network initiated bearers.

It should be noted that the above presented approach can be dynamic, where it is possible to add QoS for new application and/or re-configure QoS for existing applications. The list of recommended codec and bit rate combinations per media type, as will be demonstrated with reference to FIG. 2C, can also be updated, e.g. as networks are upgraded to support higher bit rates and/or policies change.

Referring to FIG. 2B, there is a block diagram that illustrates in greater detail the format of an exemplary QoS database 222. The exemplary QoS database 222 shown has one table 226a, 226b . . . 226n per application 228a, 228b . . . 228n (e.g., a push-to-talk over cellular (PoC) application, a VoIP application, a video application, a file transfer application). Each table 226a, 226b . . . 226n has one or more rows 230a, 230b . . . 230n where each individual row is associated with a media type, e.g., voice or video. In particular, each individual row 230a, 230b . . . 230n contains a media type 232a, 232b . . . 232n, a requested QoS parameter set 234a, 234b . . . 234n and an optional minimum QoS parameter set 236a, 236b . . . 236n. For example, the first table 226a which could be associated with a PoC application 228a has five rows 230a each of which is associated with a specific media type that has been identified as “General Purpose”, “AMR00”, “AMR04”, “AMR07” and “AMR*”. The “AMR” indicates an adaptive multi-rate and the “*” indicates a wildcard. This exemplary QoS database 222 happens to have tables 226a, 226b . . . 226n which are defined to organize and store QoS parameters that would be used within the IMS architecture.

Referring to FIG. 2C, there is a block diagram that illustrates in greater detail the format of another exemplary QoS database 222′. The exemplary QoS database 222′ shown has one table 226a′, 226b′ . . . 226n′ per application 228a′, 228b′ . . . 228n′ (e.g., a push-to-talk over cellular (PoC) application, a VoIP application, a video application, a file transfer application). Each table 226a′, 226b′ . . . 226n′ has one or more rows 230a′, 230b′ . . . 230n′ where each individual row is associated with a media type, e.g., voice or video. In particular, each individual row 230a′, 230b′ . . . 230n′ contains a preferred codec 231a, 231b . . . 231n, a media type 232a′, 232b′ . . . 232n′, a requested QoS parameter set 234a′, 234b′ . . . 234n′ and an optional minimum QoS parameter set 236a′, 236b′ . . . 236n′. For example, the first table 226a′ which could be associated with a PoC application 228a′ has five rows 230a′ each of which is associated with preferred codecs “Voice AMR-WB”, “Voice AMR”, “Video MPEG4”, “Video H.264”, “Text” identified to respective specific media type and bit rate combination. There is further information about requested QoS and minimum QoS for the combinations in the rows. This exemplary QoS database 222′ has tables 226a′, 226b′ . . . 226n′ which are defined to organize and store QoS parameters that would be used within the IMS architecture.

In case of end-to-end application level negotiation signaling, such as SIP/SDP negotiation, the list of recommended codec and bit rate combinations per media type can be used to limit the set of combinations used in the negotiation.

The requested QoS is used by the UE in PDP Context Activation procedure. The minimum QoS can be used by the UE in deciding whether or not to accept a QoS proposed by the network. In case of network requested PDP Context Activation, the requested QoS is determined by the network and signaled to the UE. Also here, the list of recommended codec and bit rate combinations per media type can be used to limit the set of combinations used in any end-to-end application level negotiation.

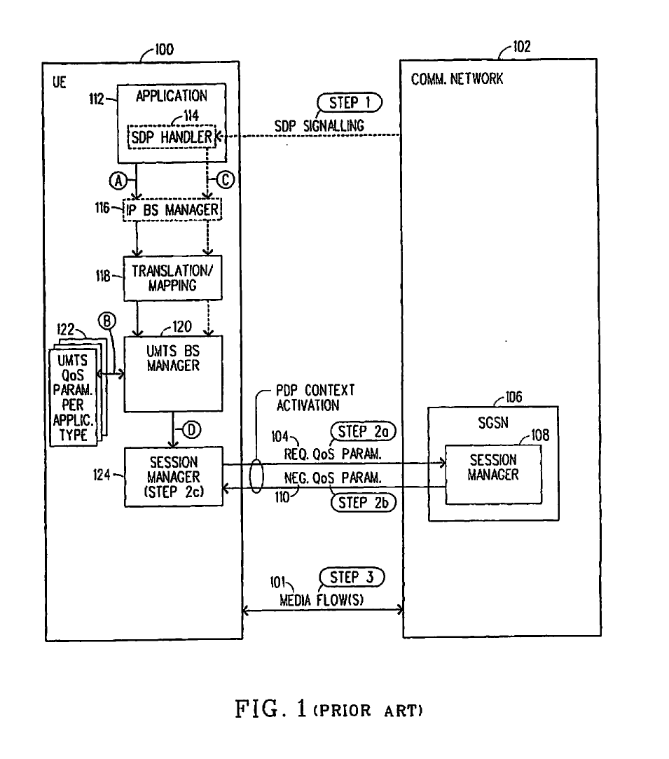

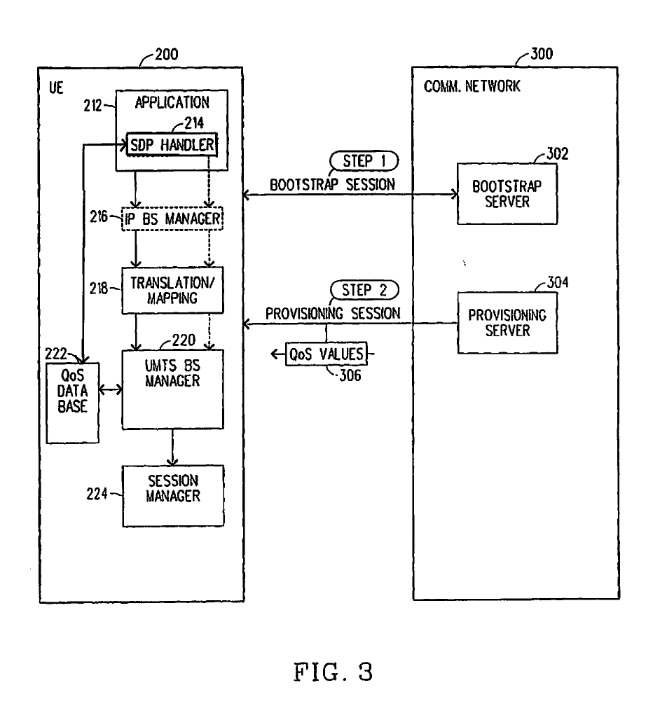

Referring to FIG. 3, there is shown a block diagram explains how an operator can use a communication network 300 to populate/provision the UE's QoS database 222 in accordance with the present invention. The communication network 300 is shown as having a bootstrap server 302 and a provisioning server 304. In operation, the UE 200 and the bootstrap server 302 can initiate a bootstrap session with one another over the air to establish a secure relationship (see step 1). Or, the bootstrap server 302 can store the bootstrap message (key) on a smart card which is inserted into the UE 200. The UE 200 and the provisioning server 304 then initiate a provisioning session with one another over the air so the provisioning server 304 can send QoS values 306 to the UE 200 which are stored within the QoS database 222 (see step 2). In particular, the provisioning server 304 (or the UE 200) can initiate the provisioning session using a key that was obtained during the bootstrap session. Then, the provisioning server 304 can send the QoS values 306 to the UE 200 which stores them within the QoS database 222. Alternatively the bootstrap server 302 could place the QoS values directly into the bootstrap message which is stored in a smart card that is inserted into the UE 200. This alternative is a simpler way for sending QoS values to the UE 200, because there are no messages that need to be sent from the UE 200 to the communication network 300. In either case, the operator can utilize the bootstrap server 302 and/or the provisioning server 304 to effectively populate/provision the QoS database 222. The operator can also use the bootstrap server 302 and/or provisioning server 304 to fine-tune (update) the QoS database 222. The SDP handler 214 is arranged to access the QoS database 222. Since the QoS database 222 provides appropriate information to the SDP handler 214 for SIP/SDP negotiation, the negotiation is further enhanced since the operator can use the communication network 300 to populate/provision the UE's QoS database 222, which implies that feasible configurations can be assured, and thus successful activation of the application. Therefore, this enables improved efficiency in application level negotiation. The operator is enabled to control any application level negotiation to e.g. only include codec and bit rate combinations for which the required level of bearer QoS can be fulfilled by the network. This increases the probability of a successful activation of the application. This applies to use cases both with UE and network initiated bearers. This is a marked improvement over the prior art in which the operator could not do any of these things because the manufacturer provisioned/populated the QoS database 122 when the UE 100 was manufactured (see FIG. 1).

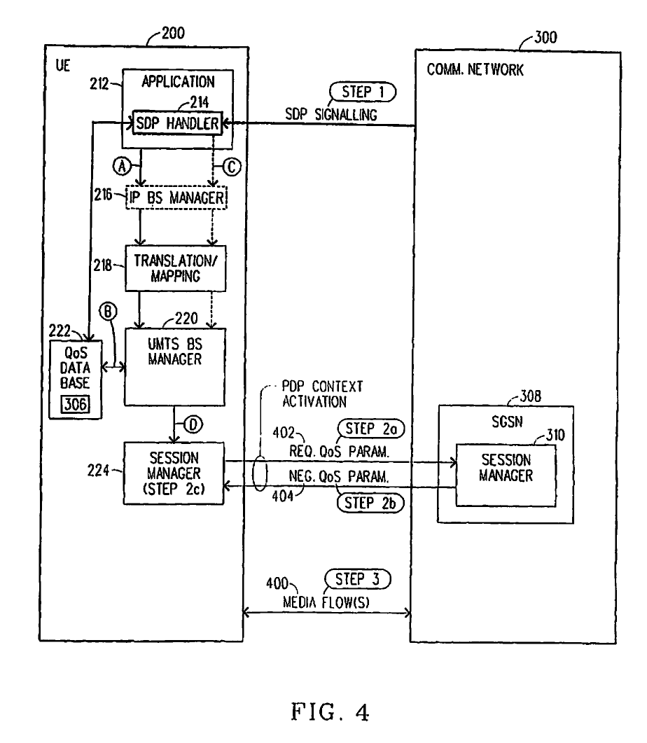

Referring to FIG. 4, there is shown a block diagram which is used to help explain how the UE 200 can use the populated QoS database 222 therein to establish an application's media flows 400 with the communication network 300 in accordance with the present invention. The SDP handler 214 is arranged to access the QoS database 222 to enable efficient application level negotiation, as demonstrated above with reference to FIGS. 2 and 3. Initially, the UE 200 (in particular the application 212) and communication network 300 (which in this example has an IMS architecture) utilize SDP signaling to negotiate on an application level what type of application 400 (e.g., a PoC application, a VoIP application, a video application, a file transfer application) they want to establish (see step 1). Then, the UE 200 (in particular a session manager 224) and the communication network 300 (in particular a session manager 310) attempt to activate the bearer(s) (Packet Data Protocol (PDP) context(s)) which are needed to establish the application's media flow(s) 400 (see steps 2a-2c). For example, if a video application 400 is desired then there would be a voice bearer and a video bearer which would need to be activated. And, if a voice application 400 is desired then just a voice bearer would need to be activated. How these bearer(s) are activated is discussed next.

First, the UE 200 needs to generate a requested QoS parameter set 402 for each of the media flow bearer(s) which it then forwards to a SGSN 308 (in particular the session manager 310) within the communication network 300 (see step 2a). Secondly, the session manager 310 generates and forwards a negotiated QoS parameter set 404 for each of the bearer(s) to the UE 200 (see step 2b). Thirdly, the UE 200 (in particular the session manager 224) determines whether or not to accept the negotiated QoS parameter set(s) 404 which would be used to set-up the respective bearer(s)(see step 2c). If the UE 200 accepts the negotiated QoS parameter set(s) 404, then the media flow(s) 400 is/are established with the communication network 300 (see step 3). If the UE 200 does not accept any of the negotiated QoS parameter set(s) 404, then the corresponding bearer is deactivated and the corresponding media flow 400 is not established with the communication network 300. In this document, the step where the UE 200 generates the requested QoS parameter set(s) 402 which is sent to the communication network 300 is of particular interest. How the UE 200 can generate the requested QoS parameter set(s) 402 is discussed next.

The UE 200 can generate the requested QoS parameter set(s) 402 by using the following components: the application 212; the SDP handler 214; the IP BS manager 216 (optional); the translation/mapping function 218; the UMTS BS manager 220; the QoS database 222 (e.g., enhanced UMTS QoS Parameter Per Application Type database 222); and the session manager 224. These components 212, 214, 216, 218, 220, 222 and 224 can generate the requested QoS parameter set(s) 402 as follows:

A. The application 212 provides the UMTS BS Manager 220, possibly via the IP BS Manager 216 and the Translation/Mapping function 218, the relevant information needed to perform step B or step D.

B. If needed, the UMTS BS Manager 220 uses information from step A to access a proper set of QoS Parameter sets 306 from the enhanced UMTS QoS Parameter Per Application Type database 222. In this document it is assumed that this step is performed.

C. If the SDP handler 214 is available, then the SDP Parameters therefrom could provide guidance for the UMTS BS Manager 220 (possibly via the IP BS manager 216 and the translation/mapping function 218) to set a maximum bitrate uplink/downlink (UL/DL) and a guaranteed bitrate UL/DL.

D. The QoS Parameter set(s) 306 from step B (or QoS Parameter values from step A) is possibly merged at the session manager 224 together with the maximum bitrate UL/DL and the guaranteed bitrate UL/DL from step C. The result is the requested QoS parameter set(s) 402.

From the foregoing, it can be seen that the UE 200 is a marked improvement over the prior art. Because, the UE 200 has a defined QoS database 222 which can be provisioned and/or fine-tuned over the air by an operator of a communication network 300. The UE 200 also has many other advantages as well some of which are discussed in the following list:

The QoS database 222 has tables 226a, 226b . . . 226n which can store QoS parameter sets 306 that are based on the QoS requirements of a particular type of communication network 300 (e.g., a communication network 300 with an IMS architecture). This is important because there are many different types of communication networks.

The operator can populate the QoS database 222 for existing applications and future applications. And, the operator can populate the QoS database 222 with QoS parameter sets that they would like to use to help establish the application's media flow(s) 400 within their communication network 300.

It should be appreciated that not all of the requested QoS parameters 404 need to be provisioned. Instead, some of the QoS parameters may be created with other mechanisms. For instance, it is possible to calculate some of the QoS values within the UE 200. As such, the UE 200 could select between QoS parameters that are calculated and QoS parameters that are provisioned. And, the UE 200 may not even need to expose the calculated QoS parameters to the provisioning server 304.

A benefit of having one table per application is that there is no need to standardize globally unique media type identifiers between different organizations. It is usually very hard to maintain a global registration organization and if this solution is used this is not needed.

The user of UE 200 does not have to worry about the QoS settings within the QoS database 222. In fact, because an operator can populate the QoS database 222 they can also make sure the QoS is coupled to the quality perceived by the user and to the network characteristics.

The SDP handler 214 is arranged to access the QoS database, which implies more efficient application level negotiation.

The QoS database 222 has one table per application which avoids a need to use globally unique identifiers which are required if a global QoS database is used. This means that the definitions of various identifiers can be based on the specific applications which are supported/standardized by specific organizations.

The present invention has been described mostly from a UE point of view, since the QoS database is held by the US. However, the practical use of the QoS database will also improve performance of the communication system as a whole. Improved application level negotiation will of course be appreciated by the user of the US, since the success rate of activation of applications will be strongly and positively influenced. However, it will also be appreciated by the operator of the communication network for the same reason. The improvements will be evident for n UE to network negotiations, but the improvements will also be evident for end-to-end application level negotiation signaling. Examples on negotiations are given in WO2007/039430, WO2007/039431, WO2007/039432, and WO2007/039433, which are hereby incorporated by reference. The present invention may be particularly advantageous for improving the negotiations disclosed in any of these.

Although one embodiment of the present invention has been illustrated in the accompanying Drawings and described in the foregoing Detailed Description, it should be understood that the invention is not limited to the embodiment disclosed, but is capable of numerous rearrangements, modifications and substitutions without departing from the spirit of the invention as set forth and defined by the following claims.

1. A device, comprising:
an application level negotiation handler; and
a database including a plurality of tables, where each table is associated with a particular application, and where each table has a plurality of rows, and where each row includes a media type and a requested quality of service parameter set,
wherein the application level negotiation handler is arranged to access the database.

2. The device of claim 1, wherein each row further includes a minimum quality of service parameter set, or a preferred codec, or a combination thereof.

3. The device of claim 2, further comprising a session manager that attempts to set-up a bearer with a communication network by:
obtaining, from the database, the requested quality of service parameter set and the minimum quality of service parameter set of the media type associated with the bearer;
sending, to the communication network, the requested quality of service parameter set;
receiving, from the communication network, a negotiated quality of service parameter set; and
determining whether to accept the negotiated quality of service parameter set by comparing the negotiated quality of service parameter set to the minimum quality of service parameter set.

4. The device of claim 1, wherein said application is one selected from the group consisting of: a voice over Internet Protocol application, a push-to-talk over cellular application, a video application, and a file transfer application.

5. The device of claim 1, wherein said database is remotely populated over the air by an operator.

6. The device of claim 1, wherein said database is fine-tuned over the air by an operator.

7. A communication system, comprising:
a bootstrap server;
a provisioning server; and
a User Equipment (UE);
the UE and the bootstrap server being adapted to initiate a bootstrap session with one another over the air to establish a secure relationship;
the UE having an application level negotiation handler and a database including a plurality of tables, where each table is associated with a particular application, and where each table has a plurality of rows, and where each row includes a media type and a requested quality of service parameter set, wherein the application level negotiation handler is arranged to access the database.

8. The communication system of claim 7, wherein each row further includes a minimum quality of service parameter set, or a preferred codec, or a combination thereof.

9. The communication system of claim 8, further comprising, in the UE, a session manager that attempts to set-up a bearer with a communication network by:
obtaining, from the database, the requested quality of service parameter set and the minimum quality of service parameter set of the media type associated with the bearer;
sending, to the communication network, the requested quality of service parameter set;
receiving, from the communication network, a negotiated quality of service parameter set; and
determining whether to accept the negotiated quality of service parameter set by comparing the negotiated quality of service parameter set to the minimum quality of service parameter set.

10. The communication system of claim 7, wherein said application is one selected from the group consisting of: a voice over Internet Protocol application, a push-to-talk over cellular application, a video application, and a file transfer application.

11. The communication system of claim 7, wherein said database is remotely populated over the air by an operator.

12. The communication system of claim 7, wherein said database is fine-tuned over the air by an operator.

13. A method for provisioning a database within a device, said method comprising the steps of:
establishing a secure relationship over the air with said device;
populating said database within said device over the air with information that is associated with one or more applications, wherein said database includes a plurality of tables, where each table is associated with one of the applications, and where each table has a plurality of rows, and where each row is populated with information such as a media type and a requested quality of service parameter set; and
accessing said database from an application level negotiation handler.

14. The method of claim 13, wherein each row further includes a minimum quality of service parameter set, or a preferred codec, or a combination thereof.

15. The method of claim 13, further comprising the step of fine-tuning over the air said populated database.

16. The method of claim 13, wherein said applications at least one of the applications selected from the group consisting of a voice over Internet Protocol application,
a push-to-talk over cellular application, a video application, and a file transfer application.

17. A method for enabling a device to establish an application media flow with a communication network, said method comprising the step of:
negotiating what type of media flow is to be established with the communication network, said negotiating step further comprising:
interacting with a database which includes a plurality of tables, where each table is associated with a particular application, and where each table has a plurality of rows, and where each row includes a media type, a requested quality of service parameter set and a minimum quality of service parameter set;
obtaining, from the database, the requested quality of service parameter set and the minimum quality of service parameter set of the media type associated with the application;
sending, to the communication network, the requested quality of service parameter set;
receiving, from the communication network, a negotiated quality of service parameter set; and
determining whether to accept the negotiated quality of service parameter set by comparing the negotiated quality of service parameter set to the minimum quality of service parameter set.

18. The method of claim 17, wherein said application is one selected from the group consisting of a voice over Internet Protocol application, a push-to-talk over cellular application, a video application, or a file transfer application.

19. The method of claim 17, wherein said database is populated over the air by an operator.

20. The method of claim 17, wherein said database is fine-tuned over the air by an operator.
